(19) United States
(12) Patent Application Publication
(10) Pub. No.: US 2025/0123638 A1
(43) Pub. Date: Apr. 17, 2025

(54) AUTONOMOUS DRIVING VEHICLE AND CONTROL METHOD THEREOF

(71) Applicants: Hyundai Motor Company, Seoul (KR); Kia Corporation, Seoul (KR)

(72) Inventor: Jun Hyuk CHOI, Hwaseong-si (KR)

(73) Assignees: Hyundai Motor Company, Seoul (KR); Kia Corporation, Seoul (KR)

(21) Appl. No.: 18/908,207

(22) Filed: Oct. 7, 2024

(30) Foreign Application Priority Data
Oct. 13, 2023 (KR) 10-2023-0136670

(51) Int. Cl. G05D 1/86; G05D 1/243; G05D 1/246; G05D 1/617; G05D 1/81; G05D 109/10

(52) U.S. Cl. CPC G05D 1/86; G05D 1/243; G05D 1/246; G05D 1/617; G05D 1/81; G05D 2109/10

(57) ABSTRACT

A method of controlling an autonomous vehicle includes: under the control of a processor, receiving external information from an external source and updating the external information into navigation map information; predicting an avoidance area, which is an electromagnetic disturbance area, based on the updated navigation map information; determining whether the autonomous vehicle enters the predicted avoidance area while the autonomous vehicle drives on a road; and generating a warning signal related to an occurrence of an error in the autonomous vehicle based on a result of the determining.

### CROSS-REFERENCE TO RELATED APPLICATION

The present application claims priority to Korean Patent Application No. 10-2023-0136670, filed on Oct. 13, 2023, the entire contents of which is incorporated herein for all purposes by this reference.

### BACKGROUND OF THE PRESENT DISCLOSURE

### Field of the Present Disclosure

The present disclosure relates to an autonomous vehicle and a control method thereof.

### Description of Related Art

An autonomous vehicle utilizes various detecting devices such as radio detection and ranging (radar)s, LiDARs, cameras, and the like, and there may thus be a probability that a malfunction thereof occurs due to unnecessary electric waves.

For example, with a vehicle-to-everything (V2X) function in operation, the autonomous vehicle may have a greater probability of malfunction due to electromagnetic interference.

For example, the autonomous vehicle may experience a malfunction by traveling through a red light at an intersection even though a wireless transmitter of a camera for broadcasting detects the red light due to electromagnetic interference during autonomous driving of level 4 or 5, or the autonomous vehicle may experience a malfunction by traveling straight against a right turn due to electromagnetic interference with a V2X signal during the demonstration of autonomous driving of level 3.

To prevent these, there have been efforts to enhance various shielding technologies, but complete shielding may be challenging in terms of feasibility and costs due to the characteristics of electromagnetic waves.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an autonomous vehicle and a control method thereof which may prevent in advance a malfunction caused by electromagnetic interference which may occur during autonomous driving.

The technical objects to be achieved by the present disclosure are not limited to those described above, and other technical objects not described above may also be clearly understood by those skilled in the art from the following description.

To solve the preceding technical problems, according to an exemplary embodiment of the present disclosure, there is provided a method of controlling an autonomous vehicle including a processor, the method including, by a control of the processor, receiving external information from an external source, and updating navigation map information based on the external information, predicting an avoidance area of an electromagnetic disturbance area based on the updated navigation map information, determining whether the autonomous vehicle enters the avoidance area while the autonomous vehicle drives on a road, and generating a warning signal related to an occurrence of an error in the autonomous vehicle based on a result of the determining.

Furthermore, the error in the autonomous vehicle may include an internal operation error predicted to occur in vehicle electronic units mounted on the autonomous vehicle and/or an autonomous driving operation error of the autonomous vehicle predicted to occur during autonomous driving of the autonomous vehicle.

Furthermore, the method may include, under the control of the processor, in response to an entry of the autonomous vehicle into the avoidance area, inducing a transfer of a control authority over the autonomous vehicle to a driver.

Furthermore, the method may include, under the control of the processor, activating a search mode of searching for an avoidance path that detours around the avoidance area.

Furthermore, the method may include, under the control of the processor, displaying the avoidance path.

Furthermore, the method may include, under the control of the processor, outputting the generated warning signal to a display unit mounted on the autonomous vehicle.

Furthermore, the method may include, under the control of the processor, storing a first operating state of the vehicle electronic units operating before the autonomous vehicle enters the avoidance area, and analyzing a second operating state of the vehicle electronic units operating after the autonomous vehicle exits the avoidance area, in comparison to the first operating state.

Furthermore, the method may include, under the control of the processor, restoring the vehicle electronic units into the stored first operating state in response that a difference between the first operating state and the second operating state is greater than or equal to a predetermined range, and maintaining the second operating state in response that the difference is smaller than the predetermined error range.

Furthermore, the external information may include information related to locations of electric power transmitting stations or substations, information related to airports or seaports, and information related to predicted thunderstroke areas.

To solve the preceding technical problems, according to an exemplary embodiment of the present disclosure, there is provided a computer-readable recording medium storing a program for executing autonomous driving of the autonomous vehicle based on the method described above.

To solve the preceding technical problems, according to an exemplary embodiment of the present disclosure, there is provided an autonomous vehicle including a processor. The processor may be configured to receive external information from an external source and update navigation map information based on the external information, predict an avoidance area of an electromagnetic disturbance area, based on the updated navigation map information, determine whether the autonomous vehicle enters the avoidance area while the autonomous vehicle drives on a road, and generate a warning signal related to an occurrence of an error in the autonomous vehicle based on a result of the determining.

Furthermore, the error in the autonomous vehicle may include an internal operation error predicted to occur in vehicle electronic units mounted on the autonomous vehicle and/or an autonomous driving operation error of the autonomous vehicle predicted to occur during autonomous driving of the autonomous vehicle.

Furthermore, the processor may be configured to, in response to an entry of the autonomous vehicle into the avoidance area, induce a transfer of a control authority of the autonomous vehicle to a driver.

Furthermore, the processor may be configured to activate a search mode of searching for an avoidance path that detours around the avoidance area.

Furthermore, the processor may be configured to display the avoidance path.

Furthermore, the processor may be configured to output the generated warning signal to a display unit mounted on the autonomous vehicle.

Furthermore, the processor may be configured to store a first operating state of the vehicle electronic units operating before the autonomous vehicle enters the avoidance area, and analyze a second operating state of the vehicle electronic units operating after the autonomous vehicle exits the avoidance area, in comparison to the first operating state.

Furthermore, the processor may be configured to restore the vehicle electronic units into the stored first operating state in response that a difference between the first operating state and the second operating state is greater than or equal to a predetermined range, and maintain the second operating state in response that the difference is smaller than the predetermined error range.

Furthermore, the external information may include information related to locations of electric power transmitting stations or substations, information related to airports or seaports, and information related to predicted thunderstroke areas.

According to various exemplary embodiments of the present disclosure described herein, the autonomous vehicle and the control method, configured as described above, may improve the reliability of the autonomous vehicle by preventing a malfunction due to electromagnetic interference which may occur during autonomous driving.

Furthermore, according to various exemplary embodiments of the present disclosure described herein, the autonomous vehicle and the control method may improve the stability of the autonomous vehicle by bypassing an area in a strong electric field where electromagnetic interference may occur during autonomous driving.

Furthermore, according to various exemplary embodiments of the present disclosure described herein, the autonomous vehicle and the control method may improve the reliability of the autonomous vehicle in addition to the stability of the autonomous vehicle by providing the driver with a message indicating that an error may occur in the operation of autonomous driving due to a potential electromagnetic disturbance when the autonomous vehicle is passing through an area in a strong electric field where electromagnetic interference may occur.

Furthermore, according to various exemplary embodiments of the present disclosure described herein, the autonomous vehicle and the control method may prevent a dangerous situation which may occur due to an error in the operation of autonomous driving when the autonomous vehicle is passing through a strong electric field area where electromagnetic interference may occur.

The effects which may be achieved from the present disclosure are not limited to those described above, and other effects not described above may also be clearly understood by those skilled in the art from the following description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating an autonomous vehicle according to an exemplary embodiment of the present disclosure.

FIG. 2 is a flowchart briefly illustrating a method of controlling an autonomous vehicle according to an exemplary embodiment of the present disclosure.

FIG. 3 is a diagram illustrating an avoidance area, which is an area in a strong electric field, according to an exemplary embodiment of the present disclosure.

FIG. 4 is a diagram illustrating an avoidance path for avoiding an avoidance area according to an exemplary embodiment of the present disclosure.

FIG. 5 is a flowchart illustrating a method of controlling an autonomous vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings, and the same or similar elements will be provided the same reference numerals regardless of reference symbols, and a repeated description thereof will be omitted. Furthermore, when describing the embodiments, when it is determined that a detailed description of related publicly known technology obscures the gist of the exemplary embodiments described herein, the detailed description thereof will be omitted.

As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof. Furthermore, when describing the exemplary embodiments with reference to the accompanying drawings, like reference numerals refer to like components and a repeated description related thereto will be omitted.

Furthermore, the terms “unit” and “control unit” included in names such as a vehicle control unit (VCU) may be terms widely used in the naming of a control device or controller configured to control vehicle-predetermined functions but may not be a term that represents a generic function unit. For example, each controller or control unit may include a communication device that communicates with other controllers or sensors to control a corresponding function, a memory that stores an operating system (OS) or logic commands and input/output information, and at least one vehicle controller that is configured to perform determination, calculation, selection, and the like necessary to control the function. The vehicle controller may also be referred to herein as a drive controller.

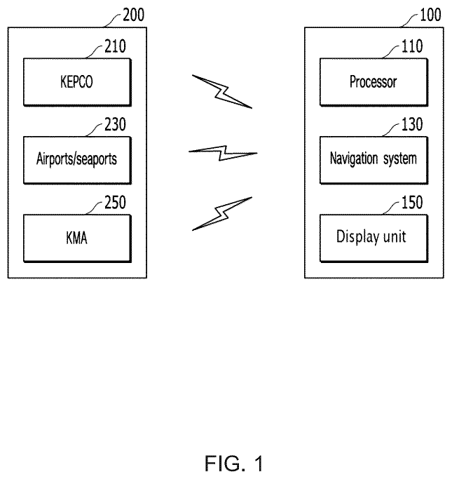

FIG. 1 is a block diagram illustrating an autonomous vehicle according to an exemplary embodiment of the present disclosure.

Referring to FIG. 1, according to an exemplary embodiment of the present disclosure, an autonomous vehicle 100 may include a processor 110, a navigation system 130, and a display unit 150, wherein the navigation system 130 and the display unit 150 are operatively connected to the processor 110.

The processor 110 may be mounted on the autonomous vehicle 100 to control the navigation system 130 and the display unit 150. The processor 110 may receive updated navigation map information from the navigation system 130 and may be configured to predict an avoidance area, which is an electromagnetic disturbance area, based on the received information. The avoidance area may be an area in a strong electric field, which is referred to herein as a strong electric field area.

The avoidance area may include, for example, a transmitting station and its vicinity, a substation and its vicinity, an airport or seaport and its vicinity, a predicted thunderstroke area, and the like.

For example, a transmitting station and a substation for converting high power and transmitting the converted power may be where electromagnetic waves are generated considerably. For example, in transmitting stations in some regions such as Dangjin and Kimje in Korea, when there is a transmission output of 1000 kilowatts (kW) or more, an electric field level of up to 100 volts per meter (V/m) or more is observed. Airports or seaports use high-intensity communication frequencies and various radars, and thus a high field distribution is observed in a band of 2 to 5 gigahertz (GHz) in airports (Incheon, Gimpo) and seaports (Incheon, Busan) and their vicinities.

The processor 110 may be configured to determine whether the autonomous vehicle 100 enters the predicted avoidance area while the autonomous vehicle 100 is traveling on a road, and may be configured to generate a warning signal associated with an occurrence of an error in the autonomous vehicle 100 based on a result of the determination. For example, when determining that the autonomous vehicle 100 has entered the avoidance area, the processor 110 may be configured to generate a warning signal and display the generated warning signal through the display unit 150. This will be described in more detail below.

The navigation system 130 may receive external information provided by an external source and update the navigation map information with the received external information, under the control of the processor 110. The external information may be information provided via an external server 200 or an external system. The external server 200 or external system may include, for example, the Korean electric Power Corporation (KEPCO) 210, airports or seaports 230, and the Korea Meteorological Administration (KMA) 250. The external information may include electric power transmitting station/substation location information, airport/seaport information, and daily KMA information.

The transmitting station/substation location information and the airport/seaport information, which are the external information, may be periodically provided by the KEPCO 210 and the airports or seaports 230, respectively. For a predicted thunderstroke area, the daily KMA information may be provided.

The navigation system 130 may receive the external information and apply it to a navigation map, under the control of the processor 110. The processor 110 may then predict or estimate an avoidance area, which is a strong electric field area, more precisely based on the airport/seaport information and directions of radars of the autonomous vehicle 100 and the like.

Accordingly, the processor 110 may apply the information to the navigation map for such a strong electric field area, and guide the autonomous vehicle 100 to avoid the area when an autonomous driving function is in operation.

The display unit 150 may be mounted on the autonomous vehicle 100 to output or display any information related to the autonomous vehicle 100. For example, the display unit 150 may include a head-up display (HUD), a head unit monitor, and the like.

The display unit 150 may output or display a warning signal, under the control of the processor 110. The warning signal may include a warning statement. For example, the warning signal may include a warning message that reads “You are passing through a strong electric field area, and autonomous driving may be unstable.”

Furthermore, the warning signal may include an internal operation error which may occur in vehicle electronic units mounted on the autonomous vehicle 100 and an autonomous driving operation error which may occur during autonomous driving of the autonomous vehicle 100. This will be described in more detail below.

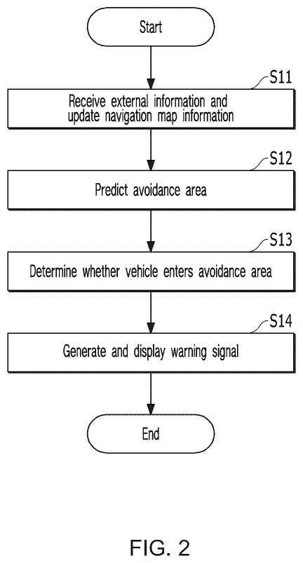

FIG. 2 is a flowchart briefly illustrating a method of controlling an autonomous vehicle according to an exemplary embodiment of the present disclosure.

Referring to FIG. 2, the method of controlling the autonomous vehicle 100 is as follows.

In step S11, the autonomous vehicle 100 may receive external information from the external server 200 or external system, and update navigation information by applying the received external information to a navigation map, under the control of the processor 110.

In step S12, the autonomous vehicle 100 may be configured to predict or estimate an avoidance area, which is a strong electric field area, based on the updated navigation map information, under the control of the processor 110. The avoidance area and the external information have been described above and will thus be omitted here for brevity.

In step S13, the autonomous vehicle 100 may be configured to determine whether it enters the avoidance area while traveling on a road or traveling on a path to a destination, under the control of the processor 110.

In step S14, when determining that it has entered the avoidance area, the autonomous vehicle 100 may be configured to generate a warning signal and output or display the generated warning signal on the display unit 150 mounted on the autonomous vehicle 100, under the control of the processor 110.

For example, when determining that the vehicle 100 has entered the avoidance area while the autonomous driving function is in operation, the autonomous vehicle 100 may warn, through the warning signal, the driver that there may be an internal operation error in vehicle electronic units by electromagnetic interference or electromagnetic disturbance and that there may be an autonomous driving operation error during autonomous driving, under the control of the processor 110.

The autonomous vehicle 100 may then change an activated state of the autonomous driving function to deactivated to induce a transfer of a control authority of the autonomous vehicle 100 to the driver, under the control of the processor 110.

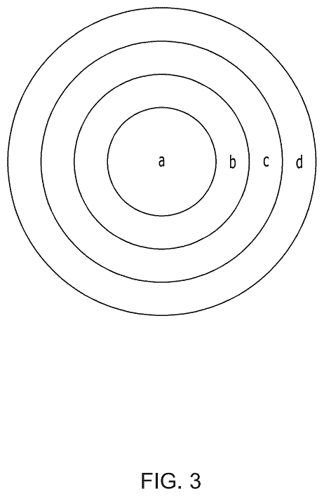

FIG. 3 is a diagram illustrating an avoidance area, which is a strong electric field area, according to an exemplary embodiment of the present disclosure.

As shown in FIG. 3, a predicted or estimated avoidance area may include a predetermined range.

For example, the avoidance area may include a predetermined range based on a center point. The predetermined range may include first, second, third and fourth ranges (e.g., a, b, c, and d).

The first range a may be a central area including the center point of the avoidance area, which may be a range with the strongest electromagnetic interference.

The second range b may be an area including the first range a, which may be a range with strong electromagnetic interference.

The third range c may be an area including the second range b, which may be a range with modest electromagnetic interference.

The fourth range d may be an area including the third range c, which may be a range with weak electromagnetic interference.

That is, the magnitude of electromagnetic interference may decrease from the first range a to the fourth range d. As the autonomous vehicle 100 approaches from the fourth range d to the first range a, a probability of an occurrence of a malfunction due to electromagnetic interference may increase.

When it has entered the avoidance area, the autonomous vehicle 100 may be configured to generate the warning signal of different intensities or messages in response to the first, second, third and fourth ranges a to d, under the control of the processor 110.

For example, when it has entered the first range a and the second range b of the avoidance area, the autonomous vehicle 100 may depart from a road on which it is traveling to stop temporarily until a control authority of the autonomous vehicle 100 is transferred to the driver, under the control of the processor 110.

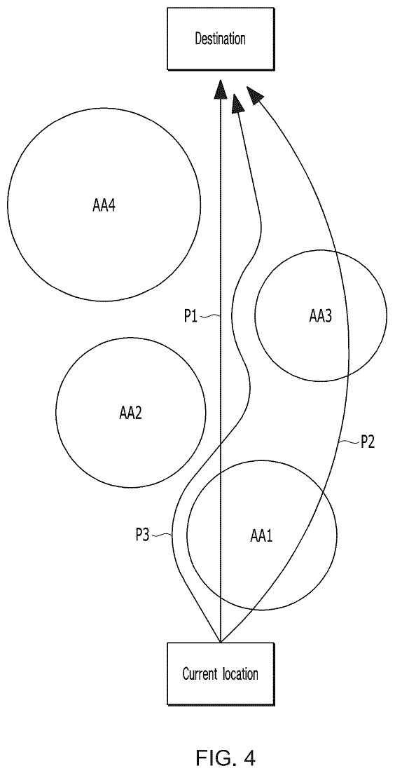

FIG. 4 is a diagram illustrating an avoidance path for avoiding an avoidance area according to an exemplary embodiment of the present disclosure.

As shown in FIG. 4, the autonomous vehicle 100 may be configured to predict or estimate an avoidance area by updating external information into navigation map information. The avoidance area may include at least one area. For example, the avoidance area may include first, second, third and fourth avoidance areas (e.g., AA1, AA2, AA3, and AA4).

When the avoidance area is predicted, the autonomous vehicle 100 may activate a search mode to search for an avoidance path that avoids the predicted avoidance area, under the control of the processor 110.

When the search mode is activated, the autonomous vehicle 100 may add and display the avoidance path to at least one path from a current location to a destination, under the control of the processor 110.

For example, the autonomous vehicle 100 may set the at least one path from the current location to the destination, under the control of the processor 110.

For example, as shown in FIG. 4, a first path P1 may be the shortest path among paths leading from a current location to a destination. A second path P2 may be an optimal path among the paths from the current location to the destination. A third path P3 may be an avoidance path among the paths from the current location to the destination.

In the instant case, the display unit 150 may display the current location, the destination, the first, second, third and fourth avoidance areas AA1 to AA4, and the first, second, and third paths P1 to P3, under the control of the processor 110. The driver may then select one from among the first, second, and third paths P1, P2 and P3 displayed on the display unit 150 by clicking on it.

When the driver selects one from among the first, second, and third paths P1, P2 and P3 by clicking on it, the display unit 150 may output a description of the selected path, under the control of the processor 110. For example, when the driver clicks to select the third path P3, the display unit 150 may output information indicating that the selected third path P3 is a path that avoids the avoidance area and autonomous driving to the destination is available, and information related to a remaining distance to the destination, an estimated time of arrival, and the like. On the other hand, when the driver clicks to select the first path P1, the display unit 150 may output information indicating that the selected first path P1 is the shortest path passing through the first avoidance area AA1 and autonomous driving to the destination is partially available, and information related to a remaining distance to the destination, an estimated time of arrival, and the like.

Furthermore, vehicle electronic units of the autonomous vehicle 100 may read various values from sensors to control the autonomous vehicle 100. However, when the autonomous vehicle 100 passes through an avoidance area, which is a strong electric field area, incorrect sensor values may be recognized, or even correctly recognized sensor values may change while passing through a transmission path. Thus, the autonomous vehicle 100 may experience a malfunction.

To prevent this, the autonomous vehicle 100 may store a first operating state of the vehicle electronic units operating immediately before the autonomous vehicle enters the avoidance area, and analyze a second operating state of the vehicle electronic units operating immediately after the autonomous vehicle exits the avoidance area, in comparison to the stored first operating state, under the control of the processor 110.

When, as a result of the analysis, a difference between the first operating state and the second operating state is out of a predetermined range, the autonomous vehicle 100 may restore the stored first operating state, under the control of the processor 110. Alternatively, when the difference is within the predetermined range, the autonomous vehicle 100 may maintain the second operating state, under the control of the processor 110.

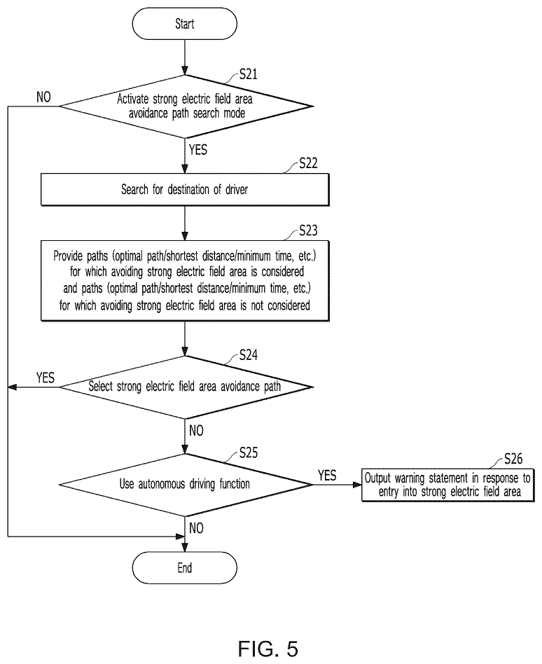

FIG. 5 is a flowchart illustrating a method of controlling an autonomous vehicle according to an exemplary embodiment of the present disclosure.

Referring to FIG. 5, the method of controlling the autonomous vehicle 100 is as follows.

In step S21, the autonomous vehicle 100 may activate/deactivate (ON/OFF) a search mode from a navigation settings screen, under the control of the processor 110. The search mode may also be referred to herein as a strong electric field area avoidance path search mode.

In step S22, the autonomous vehicle 100 may display a destination selected by the driver on the navigation settings screen, under the control of the processor 110.

In step S23, when the strong electric field area avoidance path search mode is activated from the navigation settings screen, the autonomous vehicle 100 may display an avoidance path which is based on the avoidance of a strong electric field area, along with an existing path, under the control of the processor 110.

For example, as shown in FIG. 3, the autonomous vehicle 100 may display the third path P3 (including an optimal path/shortest distance/minimum time, and the like) for which avoiding an avoidance area, which is a strong electric field area, is considered, along with the first path P1 and the second path P2 (including optimal paths/shortest distances/minimum times, and the like) for which avoiding the avoidance area, which is a strong electric field area, is not considered, under the control of the processor 110.

In the instant case, when the driver selects the third path P3 that avoids the strong electric field area in step S24, the autonomous vehicle 100 may change the activated search mode to deactivated (OFF), under the control of the processor 110.

In contrast, when the driver selects the first path P1 or the second path P2 that does not avoid the strong electric field area in step S24, the autonomous vehicle 100 may monitor whether the autonomous driving function is used, under the control of the processor 110.

When it is determined that the autonomous driving function is used in the strong electric field area in step S25, the autonomous vehicle 100 may output a warning statement to an HUD, a head unit monitor, and the like in step S26, under the control of the processor 110. The warning statement may be, for example, “You are passing through a strong electric field area, and the autonomous driving function may be unstable,” examples of which are, however, not limited thereto.

As described above, the autonomous vehicle 100 may apply such an avoidance area to a map and guide the driver not to use the autonomous driving function in the avoidance area, which is a strong electric field area, under the control of the processor 110.

The exemplary embodiments of the present disclosure described herein may be implemented as computer-readable code on a medium in which a program is recorded. The computer-readable medium may include all types of recording devices that store data to be read by a computer system. The computer-readable medium may include, for example, a Hard Disk Drive (HDD), a solid-state drive (SSD), a silicon disk drive (SDD), a read-only memory (ROM), a random-access memory (RAM), a compact disc ROM (CD-ROM), a magnetic tape, a floppy disk, an optical data storage device, and the like.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of controlling an autonomous vehicle including a processor, the method comprising:
receiving, by the processor, external information from an external source, and updating navigation map information based on the received external information;
predicting, by the processor, an avoidance area of an electromagnetic disturbance area based on the updated navigation map information;
determining whether the autonomous vehicle enters the avoidance area while the autonomous vehicle drives on a road; and
generating a warning signal related to an occurrence of an error in the autonomous vehicle based on a result of the determining.

2. The method of claim 1, wherein the error in the autonomous vehicle includes:
at least one of an internal operation error predicted to occur in vehicle electronic units mounted on the autonomous vehicle and an autonomous driving operation error of the autonomous vehicle predicted to occur during autonomous driving of the autonomous vehicle.

3. The method of claim 2, further including:
in response to an entry of the autonomous vehicle into the avoidance area, inducing, by the processor, a transfer of a control authority over the autonomous vehicle to a driver.

4. The method of claim 3, further including:
activating, by the processor, a search mode of searching for an avoidance path that detours around the avoidance area.

5. The method of claim 4, further including:
displaying, by the processor, the avoidance path.

6. The method of claim 2, further including:
outputting, by the processor, the generated warning signal to a display unit mounted on the autonomous vehicle and operatively connected to the processor.

7. The method of claim 6, further including:
storing, by the processor, a first operating state of the vehicle electronic units operating before the autonomous vehicle enters the avoidance area; and
analyzing, by the processor, a second operating state of the vehicle electronic units operating after the autonomous vehicle exits the avoidance area, in comparison to the first operating state.

8. The method of claim 7, including:
restoring, by the processor, the vehicle electronic units into the stored first operating state in response that a difference between the first operating state and the second operating state is greater than or equal to a predetermined range; and
maintaining, by the processor, the second operating state in response that the difference is smaller than the predetermined error range.

9. The method of claim 1, wherein the external information includes at least one of information related to locations of electric power transmitting stations or substations, information related to airports or seaports, and information related to predicted thunderstroke areas.

10. A non-transitory computer-readable recording medium storing a program for executing autonomous driving of the autonomous vehicle of claim 1.

11. An autonomous vehicle comprising:
a processor, wherein the processor is configured to:
receive external information from an external source and update navigation map information based on the received external information;
predict an avoidance area of an electromagnetic disturbance area, based on the updated navigation map information;
determine whether the autonomous vehicle enters the avoidance area while the autonomous vehicle drives on a road; and
generate a warning signal related to an occurrence of an error in the autonomous vehicle based on a result of the determining.

12. The autonomous vehicle of claim 11, wherein the error in the autonomous vehicle includes:
at least one of an internal operation error predicted to occur in vehicle electronic units mounted on the autonomous vehicle and an autonomous driving operation error of the autonomous vehicle predicted to occur during autonomous driving of the autonomous vehicle.

13. The autonomous vehicle of claim 12, wherein the processor is further configured to:
in response to an entry of the autonomous vehicle into the avoidance area, induce a transfer of a control authority of the autonomous vehicle to a driver.

14. The autonomous vehicle of claim 13, wherein the processor is further configured to:
activate a search mode of searching for an avoidance path that detours around the avoidance area.

15. The autonomous vehicle of claim 14, wherein the processor is further configured to:
display the avoidance path.

16. The autonomous vehicle of claim 12, wherein the processor is further configured to:
output the generated warning signal to a display unit mounted on the autonomous vehicle and operatively connected to the processor.

17. The autonomous vehicle of claim 16, wherein the processor is further configured to:
store a first operating state of the vehicle electronic units operating before the autonomous vehicle enters the avoidance area; and
analyze a second operating state of the vehicle electronic units operating after the autonomous vehicle exits the avoidance area, in comparison to the first operating state.

18. The autonomous vehicle of claim 17, wherein the processor is further configured to:
restore the vehicle electronic units into the stored first operating state in response that a difference between the first operating state and the second operating state is greater than or equal to a predetermined range; and
maintain the second operating state in response that the difference is smaller than the predetermined error range.

19. The autonomous vehicle of claim 11, wherein the external information includes:
at least one of information related to locations of electric power transmitting stations or substations, information related to airports or seaports, and information related to predicted thunderstroke areas.
